(19) United States
(12) Patent Application Publication
(10) Pub. No.: US 2015/0211563 A1
(43) Pub. Date: Jul. 30, 2015

(54) EXPANSIBLE FIXING PLUG

(71) Applicant: fischerwerke GmbH & Co. KG, Waldachtal (DE)

(72) Inventor: Aaron Daly, Pfalzgrafenweiler (DE)

(21) Appl. No.: 14/419,755

(22) PCT Filed: Aug. 2, 2013
(86) PCT No.: PCT/EP2013/002310

§ 371 Date: Feb. 5, 2015

(30) Foreign Application Priority Data
Aug. 7, 2012 (DE) 10 2012 107 235.3
Nov. 21, 2012 (DE) 10 2012 111 208.8

(51) Int. Cl. F16B 13/12

(52) U.S. Cl. CPC F16B 13/124

(57) ABSTRACT

The invention relates to an expansible fixing plug having limbs extending in a longitudinal direction of the fixing plug, from which limbs expansion elements project in opposite circumferential directions. The invention proposes constructing the expansion elements in the shape of hooks and so as to extend between one another with a spacing so that they connect the limbs by means of interlocking connections which come into effect after flexion or torsion of the expansible fixing plug or after buckling out of the limbs. The buckling, flexural and torsional strength of the fixing plug is increased.

### TECHNICAL FIELD OF INVENTION

Fixing plugs, especially made of plastic material, are known. They are mainly sleeve-shaped so that they have a hollow space extending in a longitudinal direction of the fixing plug and forming an expansion channel into which a rod-like expander means for expanding the fixing plug can be introduced for the purpose of anchoring in a drilled hole. The rod-like expander means is, for example, a nail or a screw-nail which is driven into the expansible fixing plug and expands it, or a screw which is screwed into the expansible fixing plug and expands it. There are many different arrangements of such expansible fixing plugs, especially in respect of their expansion region. The expansion region is a longitudinal portion of the expansible fixing plug which is expanded as a result of introduction of the expander means.

### DISCUSSION OF RELATED ART

European Patent Application EP 0 964 169 A2 discloses an expansible fixing plug having, arranged opposite one another and extending in a longitudinal direction of the fixing plug, two limbs from which, on both longitudinal sides, expansion elements project in a circumferential direction of the expansible fixing plug. In a side view of the expansible fixing plug, the expansion elements are triangular, with one side of the expansion elements extending in a radial plane of the expansible fixing plug and another side of the expansion elements extending on a slant relative to the expansible fixing plug. The expansion elements extend out from the two limbs in opposite circumferential directions; they fit into one another exactly without an intermediate space. When an expander screw is screwed into the expansible fixing plug, the expansion elements of the known expansible fixing plug are pivoted outwards about pivot axes that extend along the longitudinal sides of the limbs in the longitudinal direction of the plug, that is to say axially parallel to the expansible fixing plug. Pivoting of the expansion elements is possible as a result of the deformability of the expansible fixing plug, which is made of plastic material.

Patent specification DE 32 08 347 C1 discloses a sleeve-shaped expansible fixing plug also made of plastic material, having two limbs which are arranged opposite one another and which extend in a longitudinal direction of the fixing plug. Teeth project from the longitudinal sides of the limbs in opposite circumferential directions of the expansible fixing plug, the teeth of the two limbs extending in between one another in alternating manner. In a side view of the fixing plug, the teeth have a rectangular shape. Every two teeth are connected to one another by connectors extending in the longitudinal direction of the fixing plug. To the next tooth in each case there is no connection; with the exception of the connectors, there are intermediate spaces between the teeth of the expansible fixing plug. The limbs of the expansible fixing plug are connected by way of the teeth and the connectors, the connections being effective against movement of the limbs relative to one another in the longitudinal direction of the fixing plug and against movement of the limbs away from one another in the circumferential direction. Movement of the limbs relative to one another is possible as a result of flexibility of the expansible fixing plug made of plastic material. The connection of the limbs by way of the teeth and the connectors increases the flexural, buckling and torsional strength of the expansible fixing plug.

Offenlegungsschrift DE 10 2009 044 356 A1 discloses an expansible fixing plug of plastic material having, spaced apart from one another and extending in a longitudinal direction of the fixing plug, two limbs from which disc-shaped expansion elements project in radial planes of the expansible fixing plug. The disc-shaped expansion elements of the two limbs extend in between one another in the manner of combs and with an exact fit; in the non-expanded state of the expansible fixing plug, there is no spacing between the expansion elements. In a side view of the expansible fixing plug, the expansion elements have a bell shape which, starting from the limb from which they project, becomes narrower towards the limb located opposite. For expansion, the expansion elements have flat rectangular holes which only partly overlap. The holes are in each case offset relative to the limb from which the expansion element in question projects. In the course of expansion the holes are aligned, as a result of which the expansion elements move radially apart from one another and push the limbs away from one another, that is to say they expand the expansible fixing plug.

### SUMMARY OF THE INVENTION

The problem of the invention is to propose an expansible fixing plug having greater resistance to buckling on introduction into a drilled hole.

In accordance with the invention the problem is solved by the features described herein. The expansible fixing plug according to the invention, has at least two limbs extending in a longitudinal direction of the fixing plug, it being understood that “in a longitudinal direction of the fixing plug” does not only mean a straight, axially parallel course; the limbs can also have, for example, a helical or wavy course.

Expansion elements project from the limbs in opposite circumferential directions of the expansible fixing plug; it is not imperative that the expansion elements extend in radial planes—they may also extend on a slant. The limbs and the expansion elements surround a hollow space extending in the longitudinal direction of the fixing plug and forming an expansion channel into which a rod-like expander means can be introduced for expansion of the expansible fixing plug. The rod-like expander means is, for example, a nail, a screw-nail or a screw—it should not be confused with the expansion elements of the expansible fixing plug.

In accordance with the invention, the expansion elements projecting from the limbs in opposite circumferential directions extend behind one another with a spacing, so that they connect the limbs by means of interlocking connections with play. The play between the expansion elements is removed as a result of the expansible fixing plug undergoing deformation which moves the limbs relative to one another. As a result of the deformation of the expansible fixing plug and the movement of the limbs relative to one another resulting from the deformation, the expansion elements come into abutment against one another, as a result of which the interlocking connections between the expansion elements come into effect and provide resistance against further movement of the limbs relative to one another and, as a result, against greater deformation of the expansible fixing plug. Further movement of the limbs relative to one another and greater deformation of the expansible fixing plug is possible only as a result of deformation and/or movement of the mutually abutting expansion elements relative to one another. Both increase the force necessary for deformation of the expansible fixing plug and the strength of the expansible fixing plug, especially in relation to flexion, buckling and torsion and in relation to buckling-out of the limbs.

The invention allows limited deformation of the expansible fixing plug during which the force necessary for deformation of the expansible fixing plug is governed by the rigidity of the limbs. Because the rigidity of the limbs is relatively low, the expansible fixing plug according to the invention can be easily introduced into a drilled hole, even when the drilled hole does not run exactly straight. The expansible fixing plug according to the invention adapts very well to the wall of the drilled hole because of its initial deformability. So that the expansible fixing plug does not undergo too much deformation and break, the connection of the limbs of the expansible fixing plug due to the interlocking connection between the expansion elements and the abutment of the expansion elements against one another after the limited initial deformation of the expansible fixing plug counteracts movement of the limbs relative to one another in the longitudinal direction of the fixing plug and/or movement of the limbs apart from one another in a transverse direction to the fixing plug. Preferably, the connection acts both in the longitudinal direction of the fixing plug and also in a transverse direction to the fixing plug. The invention increases the strength of the expansible fixing plug according to the invention after the restricted initial deformation, especially in relation to flexion, buckling and torsion and/or buckling-out of the limbs. The invention counteracts buckling of the expansible fixing plug and buckling-out of the limbs during driving into a drilled hole when the expansible fixing plug projects just a short way into the drilled hole. Buckling-out is a movement of the limbs away from one another in a transverse direction to the expansible fixing plug, whereupon the limbs buckle. The risk of buckling is increased when the expansible fixing plug is being driven into a drilled hole using a rod-like expander means when the expander means during driving-in is lodged in a rear region of the expansible fixing plug and projects out from the rear region of the expansible fixing plug during driving-in, because it creates a longer lever arm for buckling of the expansible fixing plug. The suitability of the expansible fixing plug according to the invention for being driven into a drilled hole with a rod-like expander means already introduced a short way into the rear end of the expansible fixing plug is improved.

In a preferred embodiment of the invention, the expansion elements, when seen from a side of the expansible fixing plug, are in the shape of hooks which extend in between one another. As a result of the hook shape of the expansion elements it becomes possible by simple means for the expansion elements to extend behind one another with a spacing in the intended manner and to achieve the resultant interlocking connection of the limbs with play.

In an embodiment of the invention, slanting surfaces are provided on the outsides of the limbs, the slants of which point towards the rear end of the expansible fixing plug. The rod-like expander means is introduced into the expansible fixing plug through the rear end of the expansible fixing plug; it is accessible when the expansible fixing plug has been introduced into a drilled hole in the intended manner. In a relatively soft material such as aerated concrete, the slanting surfaces increase the resistance of the expansible fixing plug to being pulled out from a drilled hole, because of their being in contact over an area, which comes into effect on pulling out. Anchoring of the expansible fixing plug in a drilled hole is improved. An anchoring action of the limbs of the expansible fixing plug is especially increased, which makes it possible for the expansible fixing plug to cope with cracks virtually irrespectively of the orientation of the expansible fixing plug relative to the crack. A “crack” means a crack in the anchoring substrate, which passes through the drilled hole, as a result of which the drilled hole can widen in a transverse direction to the crack.

In an embodiment of the invention, a clear width of the expansion channel inside the expansible fixing plug is smaller between the expansion elements than between the limbs. The expansion channel accordingly does not have a round cross-section but rather a flat or flattened one. As a result of the smaller clear width between the expansion elements, they are expanded to a greater degree than the limbs by an expander means introduced between them. As a result, the contribution of the expansion elements to anchoring is increased.

The invention is explained hereinbelow in greater detail with reference to an exemplary embodiment shown in the drawings, in which:

### BRIEF DESCRIPTION OF THE DRAWINGS

FIG. 1 shows an expansible fixing plug according to the invention in a perspective view;

FIGS. 2, 3 and 4 each show deformations in an expansion region of the expansible fixing plug of FIG. 1; and

FIG. 5 is a cross-section through the expansible fixing plug of FIG. 1.

### DETAILED DESCRIPTION OF THE INVENTION

The expansible fixing plug 1 according to the invention shown in the drawings is, for example, made of plastic material by injection-moulding. It is sleeve-shaped and has, in a rear region, a tubular hollow shank 2 which is closed in the circumferential direction and which terminates in a hollow conical flange 3 at a rear end of the expansible fixing plug 1. To the front in the direction of introduction there is an expansion region 4 adjacent to the hollow shank 2, the “direction of introduction” being that direction in which the expansible fixing plug 1 is introduced into a drilled hole in the prescribed manner. Along the expansion region 4 there extend two limbs 5 in a longitudinal direction of the fixing plug up to a front end of the expansible fixing plug 1 where, just as at the rear of the expansion region 4 at the transition to the hollow shank 2, they are integrally connected to one another. The limbs 5 are arranged opposite one another on a circumference of the expansible fixing plug 1.

Expansion elements 6 project from longitudinal sides of the limbs 5 in opposite circumferential directions of the expansible fixing plug 1. The expansion elements 6 in each case project alternately from one, and then the other, limb 5, so that they extend in between one other in similar manner to a gear arrangement or the teeth of a zip fastener, albeit with a spacing from one another. The expansion elements 6 are hook-shaped; they project at an angle towards the rear from the limbs 5 and, after a bend in a mid-plane of the expansible fixing plug 1 between the limbs 5, they point at an angle towards the front. Alternatively, the expansion elements 6 can also, vice-versa, project from the limbs 5 at an angle towards the front and, after the bend, point at an angle towards the rear (not shown). The expansion elements 6 are not in contact with one another but rather, as said, there are spaces 10 between them when the expansible fixing plug 1 is in the non-deformed state. As a result of their hooked shape, the expansion elements 6 which extend in between one other extend behind one another and connect the limbs 5 to one another by means of an interlocking connection with play which results from the spaces 10 between the expansion elements 6.

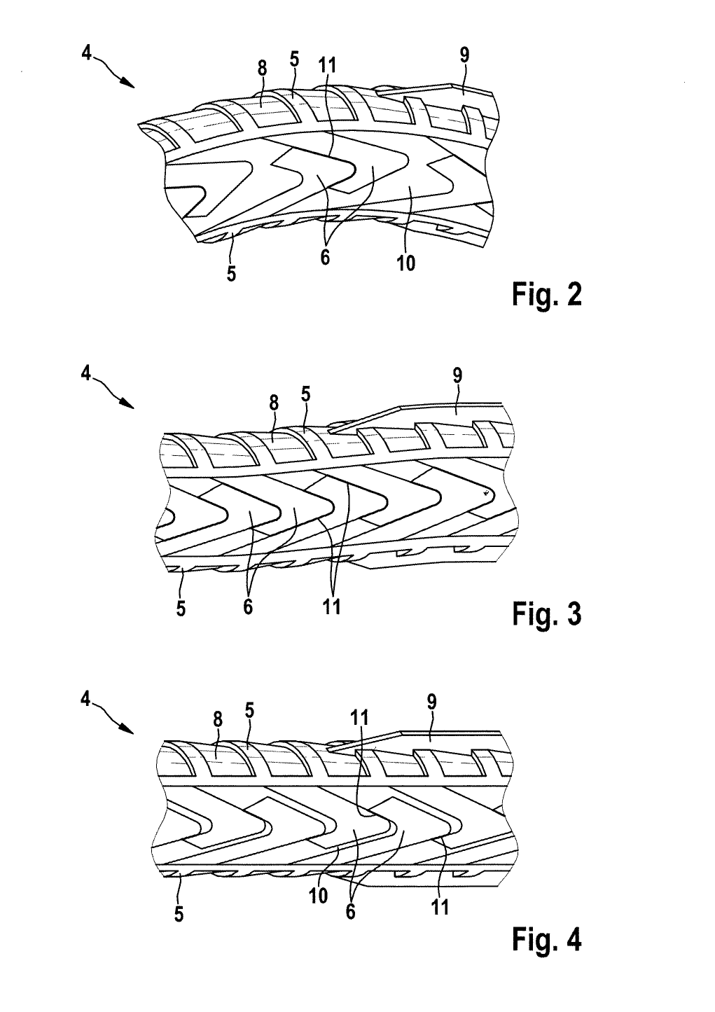

The interlocking connection comes into effect when, as a result of initial deformation of the expansion region 4 of the expansible fixing plug 1, the limbs 5 move relative to one another to the extent that the spacings 10 between the expansion elements 6 are removed and the expansion elements 6 come to abut one another (FIGS. 2 to 4). The extending of the expansion elements 6 behind one another and their interlocking connection act both in the longitudinal direction of the fixing plug and in the circumferential and/or transverse direction of the expansible fixing plug 1. If the expansible fixing plug 1 is deformed to such an extent that the expansion elements 6 move so far relative to one another that they abut one another, the expansion elements 6 counteract further movement of the limbs 5 relative to one another and—as a result—greater deformation of the expansible fixing plug 1 in the expansion region 4, as a result of which the strength of the expansible fixing plug 1 against greater deformation is increased and the possible deformation is restricted. The expansible fixing plug 1 can only undergo even greater deformation as a result of deformation of the expansion elements 6 or movement of the mutually abutting expansion elements 6 relative to one another if that is possible despite the hook shape of the expansion elements 6. When the expansion elements 6 are in abutment against one another on deformation of the expansible fixing plug 1, they connect the limbs 5 in a manner that counteracts both movement relative to one another in the longitudinal direction of the fixing plug and also movement of the limbs 5 apart from one another. Restricting the ability of the limbs 5 to move relative to one another in the longitudinal direction of the fixing plug increases the flexural, buckling and torsional strength of the expansion region 4 of the expansible fixing plug 1; restricting the ability of the limbs 5 to move apart from one another increases the buckling and torsional strength of the expansion region 4 of the expansible fixing plug 1 and counteracts buckling-out of the limbs 5, that is to say movement of the limbs 5 apart from one another and buckling in the outwards direction. Because of the spacings 10 between the expansion elements 6, the interlocking connection comes into effect only when the limbs 5 have been moved so far relative to one another that the spacings between the expansion elements 6 have been removed. This facilitates expansion of the expansible fixing plug 1.

FIG. 2 shows a deformed expansion region 4 of the expansible fixing plug 1 in a bent state. As a result of the bending, the limbs 5 of the expansible fixing plug 1 move relative to one another in the longitudinal direction of the fixing plug and external sides or external corners of each hook-shaped expansion element 6 projecting from a limb 5 of the expansible fixing plug 1 come into abutment in internal sides or internal corners of a respective other expansion element 6 projecting from the other limb 5 of the expansible fixing plug 1. Contact locations 11, where the hook-shaped expansion elements 6 abut one another as a result of the bending of the expansible fixing plug 1, are drawn with thicker lines. The abutment of the hook-shaped expansion elements 6 at the contact locations 11 provides relatively high resistance against greater bending of the expansible fixing plug 1; the flexural strength of the expansion region 4 of the expansible fixing plug 1 has been increased. In locations other than the contact locations 11, the spacings 10 between the hook-shaped expansion elements 6 may increase as a result of the bending of the expansible fixing plug 1.

FIG. 3 shows the situation in the case of torsion of the expansible fixing plug 1. Here, as a result of helical deformation of the limbs, an external side or external corner of a hook-shaped expansion element 6 projecting from a limb 5 of the expansible fixing plug 1 comes to abut the internal side or internal corner of the next hook-shaped expansion element 6 projecting from the other limb 5 of the expansible fixing plug 1. The external side or external corner of the next hook-shaped expansion element 6 projecting from the other limb 5 of the expansible fixing plug 1 in turn comes into abutment in the internal side or internal corner of yet another next hook-shaped expansion element 6 in turn projecting from a limb 5 of the expansible fixing plug 1 etc.. The contact locations 11 are shown, as in FIG. 2, with a thicker line. The resistance of the expansible fixing plug 1 to further torsion and, as a result, its torsional strength are increased.

FIG. 4 shows how the hook-shaped expansion elements 6 according to the invention, which extend between one another and behind one another with a spacing, prevent the limbs 5 of the expansible fixing plug 1 from buckling out. As a result of longitudinal compression of the expansible fixing plug 1 in the longitudinal direction of the fixing plug, the limbs 5 are bent away from one another, as a result of which the hook-shaped expansion elements 6 come to abut one another. The contact locations 11 are, as in FIGS. 2 and 3, shown with thicker lines. As a result of the hook-shaped expansion elements 6 extending behind one another the limbs 5 are prevented from moving further away from one another and, as a result, from buckling out.

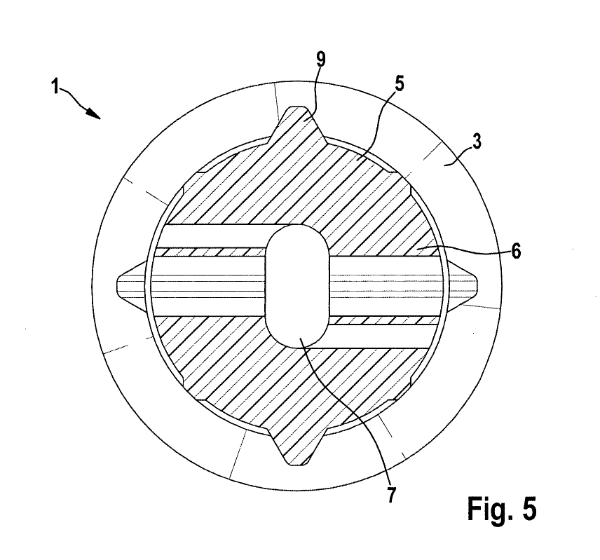

The limbs 5 and the expansion elements 6 surround a hollow space which forms an expansion channel 7 (FIG. 5) into which a screw (not shown) is screwed as expander means for expansion of the expansible fixing plug 1. The screw pushes both the expansion elements 6 and also the limbs 5 away from one other and in an outwards direction, that is to say it expands the expansible fixing plug 1. As can be seen in FIG. 5, the expansion channel 7 in the expansion region 4 is oval; its clear width between the expansion elements 6 is less than its clear width between the limbs 5. The expansion elements 6 are, as a result, expanded to a greater extent than the limbs 5. In the hollow shank 2, the expansion channel 7 has a greater diameter and is circular (not shown in the drawing).

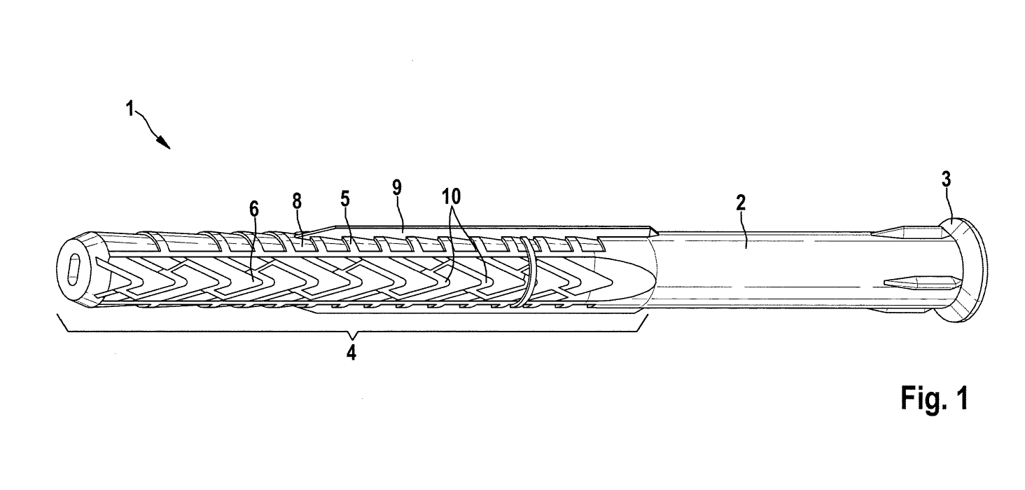

As can be seen in FIG. 1, the limbs 5 have slanting surfaces 8 which form a kind of Christmas-tree profile. The slants on the slanting surfaces 8 point towards the rear end of the expansible fixing plug 1. As a result of being in abutment over an area, the slanting surfaces 8 increase the anchoring power of the expansible fixing plug 1 in a soft anchoring substrate such as aerated concrete.

When the screw acting as expander means is being screwed in, ribs 9 running in the longitudinal direction of the fixing plug help prevent the expansible fixing plug 1 from turning too. As a result of the expansion of the limbs 5 and of the expansion elements 6 in two axial planes of the expansible fixing plug 1 that are perpendicular to one another, the expansible fixing plug 1 is able to cope with cracks largely irrespectively of the angular position of the expansible fixing plug 1 in a drilled hole: if a drilled hole in which the expansible fixing plug 1 has been anchored widens as a result of crack formation in an anchoring substrate in a transverse direction of the drilled hole, the expanded fixing plug 1 is anchored in the drilled hole largely irrespectively of an angular position of the expansible fixing plug 1 relative to the crack.

### LIST OF REFERENCE NUMERALS

1 expansible fixing plug

2 hollow shank

3 flange

4 expansion region

5 limb

6 expansion element

7 expansion channel

8 slanting surface

9 rib

10 spacing

11 contact location

1. An expansible fixing plug having at least two limbs extending in a longitudinal direction of the fixing plug and having expansion elements which project from the limbs in opposite circumferential directions, the limbs and the expansion elements surrounding a hollow space which extends in the longitudinal direction of the fixing plug and which forms an expansion channel into which a rod-like expander means can be introduced for expansion of the expansible fixing plug, wherein the expansion elements projecting from the limbs in opposite circumferential directions extend behind one another with a spacing so that the expansion elements connect the limbs by interlocking connections with play; and in that the expansion elements, after deformation of the expansible fixing plug and movement of the limbs relative to one another, come into abutment against one another, as a result of which the interlocking connection between the expansion elements comes into effect.

2. The expansible fixing plug according to claim 1, wherein the expansion elements are in the shape of hooks, which extend between one another with a spacing.

3. The expansible fixing plug according to claim 1, wherein, on their outsides, the limbs have slanting surfaces, the slants of which point towards a rear end of the expansible fixing plug.

4. The expansible fixing plug according to claim 1, wherein a clear width of the expansion channel inside the expansible fixing plug is smaller between the expansion elements than between the limbs.
